(19) United States
(12) Patent Application Publication
(10) Pub. No.: US 2025/0103922 A1
(43) Pub. Date: Mar. 27, 2025

(54) PERFORMANCE OPTIMIZATION METHOD AND APPARATUS FOR TRAINING MIXTURE-OF-EXPERTS MODEL

(71) Applicant: Tsinghua University, Beijing City (CN)

(72) Inventors: Jidong Zhai, Beijing City (CN); Jia'ao He, Beijing City (CN)

(21) Appl. No.: 18/730,671

(22) PCT Filed: Mar. 22, 2022
(86) PCT No.: PCT/CN2022/082223

§ 371 Date: Jul. 19, 2024

(30) Foreign Application Priority Data
Jan. 21, 2022 (CN) 202210071043.3

(51) Int. Cl. G06N 5/043; G06N 3/045

(52) U.S. Cl. CPC G06N 5/043; G06N 3/045

(57) ABSTRACT

The present disclosure provides a performance optimization method and apparatus for training mixture-of-experts model, which relate to the technical field of neural networks. The method includes: judging, before one iterative calculation and for each of all experts in a mixture-of-experts model, whether a current expert needs to be set as a shadow expert, and if yes, adding the current expert to a shadow expert set, and continuing to judging whether a next expert is set as a shadow expert until all the experts are judged. The present disclosure is capable of improving the speed and efficiency of training the mixture-of-experts model, and reduce the resources consumed in the mixture-of-experts model during training.

### RELATED APPLICATION

The present disclosure claims priority to Chinese Patent Application No. 202210071043.3, entitled “performance optimization method and apparatus for training mixture-of-experts model”, and filed on Jan. 21, 2022, which is hereby incorporated by reference in its entirety.

### TECHNICAL FIELD

The present disclosure relates to the technical field of neural networks, and particularly to a performance optimization method and apparatus for training a mixture-of-experts model.

### BACKGROUND

For a mixture-of-experts model in a neural network, the existing training methods mainly include Zero Optimizer, Gshard, FastMoE and the like. However, these mainstream training methods spend a lot of time in a training process of the mixture-of-experts model, and consumes many calculation resources and much electric energy; and there is still room for improvement in speed and efficiency. Therefore, it is necessary to put forward a performance optimization method for training a mixture-of-experts model to improve the training speed and efficiency of the mixture-of-experts model, and reduce the resources consumed in the mixture-of-experts model during training, so that the mixture-of-experts model can converge to a stable state more quickly during training and can be put into practical applications as soon as possible.

### SUMMARY

An objective of the present disclosure is to provide a performance optimization method for training a mixture-of-experts model, so as to solve the problem that the training process of the mixture-of-experts model consumes a lot of time, calculation resources and electric energy. Another objective of the present disclosure is to provide a performance optimization apparatus for training a mixture-of-experts model. Still another objective of the present disclosure is to provide a computer device. Yet another objective of the present disclosure is to provide a readable medium.

In order to achieve the above objectives, an aspect of the present disclosure discloses a performance optimization method for training a mixture-of-experts model, including:
judging, before one iterative calculation and for each of all experts in the mixture-of-experts model, whether a current expert needs to be set as a shadow expert, and if yes, adding the current expert to a shadow expert set, and continuing to judging whether a next expert needs to be set as a shadow expert until all the experts are judged;
the judging whether the current expert needs to be set as a shadow expert includes:
calculating a first total delay time of a mixture-of-experts model that is based on a current shadow expert set in an iterative calculation;
calculating a second total delay time of the mixture-of-experts model that is based on the current shadow expert set in an iterative calculation after adding the current expert to the shadow expert set; and
judging whether to set the current expert as the shadow expert based on the first total delay time and the second total delay time.

Optionally, the calculating a first total delay time of a mixture-of-experts model that is based on a current shadow expert set in the iterative calculation includes:
acquiring a first calculation time and a first communication time of each of servers in the mixture-of-experts model that is based on the current shadow expert set in the iterative calculation;
obtaining a first delay time of each of the servers in the iterative calculation based on the first calculation time and the first communication time of each of the servers in the mixture-of-experts model that is based on the current shadow expert set in the iterative calculation; and
selecting, from the first delay times of all the servers in the iterative calculation, the first delay time with a maximum value as the first total delay time.

Optionally, the acquiring the first calculation time and the first communication time of each of servers in the mixture-of-experts model that is based on the current shadow expert set in the iterative calculation includes:
obtaining the first calculation time based on a first input data amount of each of the servers, a hidden layer size ratio, a feature vector length of the mixture-of-experts model and a calculation throughput; and
obtaining the first communication time based on the first input data amount of each of the servers, the feature vector length of the mixture-of-experts model and a network bandwidth.

Optionally, obtaining the first delay time of each of the servers in the iterative calculation based on the first calculation time and the first communication time of each of the servers in the mixture-of-experts model that is based on the current shadow expert set in the iterative calculation includes:
summing the first calculation time and the first communication time of each of the servers in the iterative calculation to obtain the first delay time of each of the servers in the iterative calculation.

Optionally, calculating the second total delay time of the mixture-of-experts model that is based on the current shadow expert set in the iterative calculation after adding the current expert to the shadow expert set includes:
acquiring a second calculation time and a second communication time of each of the servers in the mixture-of-experts model in the iterative calculation after adding the current expert to the shadow expert set;
obtaining a second delay time of each of the servers in the iterative calculation based on the second calculation time and the second communication time of each of the servers in the iterative calculation; and
selecting, from the second delay times of all the servers in the iterative calculation, the second delay time with a maximum value as the second total delay time.

Optionally, acquiring the second calculation time and the second communication time of each of the servers in the mixture-of-experts model in the iterative calculation after adding the current expert to the shadow expert set includes:
obtaining the second calculation time based on a second input data amount of each of the servers, a hidden layer size ratio, a feature vector length of the mixture-of-experts model and a calculation throughput; and
obtaining the second communication time based on the number of shadow experts in the shadow expert set, the hidden layer size ratio, the feature vector length of the mixture-of-experts model and a network bandwidth.

Optionally, obtaining the second delay time of each of the servers in the iterative calculation based on the second calculation time and the second communication time of each of the servers in the iterative calculation includes:
summing the second calculation time and the second communication time of each of the servers in the iterative calculation to obtain the second delay time of each of the servers in the iterative calculation.

Optionally, judging whether to set the current expert as a shadow expert based on the first total delay time and the second total delay time includes:
judging whether the second total delay time is less than the first total delay time; if yes, judging to set the current expert as a shadow expert; and if not, judging not to set the current expert as a shadow expert.

Optionally, before the calculating the first total delay time of the mixture-of-experts model that is based on the current shadow expert set in the iterative calculation, the method further includes:
acquiring an input data amount of each of all the experts, and sorting all the experts in a descending order of the input data amounts of all the experts, to sequentially judge whether the current expert needs to be set as a shadow expert for each of all the experts based on an order after the sorting.

Optionally, before the calculating the first total delay time of the mixture-of-experts model that is based on a current shadow expert set in the iterative calculation, the method further includes a process of matching input data with each of all the experts in the mixture-of-experts model:
calculating, for each of all input data of the mixture-of-experts model, a matching score between the input data and each of all the experts in the mixture-of-experts model, and matching the input data with an expert having a highest matching score;
judging, for each of all the experts in the mixture-of-experts model, whether an amount of input data passing through an upper-layer network in the input data and matched with the expert is less than a first preset amount; if yes, ending the process of matching the input data with the expert; and if not, selecting the first preset amount of input data having a highest matching score from the input data passing through the upper-layer network; and
re-matching each of the unselected input data passing through the upper-layer network with the expert having the highest matching score and not communicating through the upper-layer network.

Optionally, the first preset amount is determined by a process of:
determining the first preset amount based on a bandwidth of the upper-layer network, a bandwidth of the lower-layer network, an amount of the input data to be sent by each of the servers in each of the lower-layer networks, and the number of the experts in each of the lower-layer networks.

Optionally, after judging whether to set the current expert as a shadow expert based on the first total delay time and the second total delay time, the method further includes:
grouping all the servers where the experts in the mixture-of-experts model are located based on a preset grouping mode to obtain a plurality of server groups; and
allocating, for each of the plurality of server groups, a process that a current server group receives the input data sent by other server groups, a process that the current server group calculates the input data sent by other server groups, and the process that the current server group sends a calculation result back to other server groups, to a plurality of threads based on a sequential dependency of the processes.

Optionally, the preset grouping mode is based on a pairwise exchange algorithm or a groupwise exchange algorithm.

Optionally, the plurality of threads include a first preset thread and a second preset thread.

Optionally, the allocating the process that the current server group receives the input data sent by other server groups, the process that the current server group calculates the input data sent by other server groups, and the process that the current server group sends the calculation result back to 10 other server groups, to a plurality of threads based on the sequential dependency of the processes specifically includes:
allocating the process that the current server group receives the input data sent by other server groups and the process that the current server group sends the calculation result back to other server groups to the first thread based on the sequential dependency of the processes, and allocating the process that the current server group calculates the input data sent by other server groups to the second thread based on the sequential dependency of the processes.

Optionally, the method further includes an iterative calculation process of:
copying each of the shadow experts in the shadow expert set to obtain a shadow model,
and sending the shadow models of all the shadow experts to other servers in the mixture-of-experts model;
calculating gradients of the experts and the shadow models by the shadow models and the experts on all the servers in the mixture-of-experts model based on the corresponding input data, and returning the gradients of the shadow models to the servers of the respective shadow experts; and
obtaining the gradients of the shadow experts based on the gradients of all the received shadow models, obtaining a comprehensive gradient based on the gradients of the shadow experts and other experts, and updating all the experts based on the comprehensive gradient.

In order to achieve the above objectives, another aspect of the present disclosure discloses a performance optimization apparatus for training a mixture-of-experts model, including:
a shadow expert setting module configured to judge, before one iterative calculation and for each of all experts in a mixture-of-experts model, whether a current expert needs to be set as a shadow expert, and if yes, adding the current expert to a shadow expert set, and continuing to judging whether a next expert needs to be set as a shadow expert until all the experts are judged; and
a shadow expert judging module configured to calculate a first total delay time of a mixture-of-experts model that is based on a current shadow expert set in an iterative calculation;
calculate a second total delay time of the mixture-of-experts model that is based on the current shadow expert set in an iterative calculation after adding the current expert to the shadow expert set; and judge whether to set the current expert as the shadow expert based on the first total delay time and the second total delay time.

The present disclosure further discloses a computer device, including a memory, a processor, and a computer program stored in the memory and executable on the processor, and when executing the program, the processor implements the afore-mentioned method.

The present disclosure further discloses a computer-readable medium storing a computer program, and when executed by a processor, the program implements the afore-mentioned method.

According to the performance optimization method and apparatus for training a mixture-of-experts model provided by the present disclosure, it is judged, before one iterative calculation and for each of all experts in a mixture-of-experts model, whether a current expert needs to be set as a shadow expert; if yes, the current expert is added to a shadow expert set, and it is continued to judge whether a next expert needs to be set as a shadow expert until all the experts are judged. Thus, it is possible to reduce the number of pieces of input data processed by a singular expert in a server in the mixture-of-experts model during training, thereby reducing a processing load of the singular expert in the server, and it is also possible to reduce the number of times of communications of the input data transmitted across the server, thereby improving the training speed and efficiency of the mixture-of-experts model, and reducing the resources consumed in the mixture-of-experts model during training. By calculating a first total delay time of a mixture-of-experts model that is based on a current shadow expert set in an iterative calculation, it is possible to obtain the time spent by the mixture-of-experts model that is based on the current shadow expert set in one training process, i.e., one iterative calculation. By calculating a second total delay time of the mixture-of-experts model iterative calculation that is based on the current shadow expert set in an iterative calculation after adding the current expert to the shadow expert set, it is possible to obtain the time spent by the mixture-of-experts model that is based on the current shadow expert set after adding the current expert to the shadow expert set in one training process, i.e., one iterative calculation. By judging whether to set the current expert as a shadow expert based on the first total delay time and the second total delay time, it is possible to judge whether the time spent by the mixture-of-experts model in one training process can be reduced after the current expert is set as a shadow expert, thereby improving the training speed and efficiency of the mixture-of-experts model. To sum up, the performance optimization method and apparatus for training a mixture-of-experts model provided by the present disclosure can improve the training speed and efficiency of the mixture-of-experts model and reduce the resources consumed in the mixture-of-experts model during training.

### BRIEF DESCRIPTION OF THE DRAWINGS

In order to illustrate the technical solutions in the embodiments of the present disclosure or in the prior art more clearly, the drawings to be used the description of the embodiments or the prior art will be briefly introduced below. Obviously, the drawings involved in the following description only illustrate some embodiments of the present disclosure, and those of ordinary skill in the art may obtain other drawings from them without paying any inventive effort.

FIG. 1 illustrates a performance optimization method for training a mixture-of-experts model according to an embodiment of the present disclosure;

FIG. 2 illustrates a specific method flow of an optional step S101 according to an embodiment of the present disclosure;

FIG. 3 illustrates a specific method flow of an optional step S102 according to an embodiment of the present disclosure;

FIG. 4 illustrates a module diagram of a performance optimization apparatus for training a mixture-of-experts model according to an embodiment of the present disclosure;

FIG. 5 illustrates an optional network architecture involved in a mixture-of-experts model according to an embodiment of the present disclosure;

FIG. 6 illustrates an optional thread allocation diagram according to an embodiment of the present disclosure; and

FIG. 7 illustrates a structural diagram of a computer device suitable for implementing an embodiment of the present disclosure.

### DESCRIPTION OF THE EMBODIMENTS

The technical solutions in the embodiments of the present disclosure will be clearly and completely described with reference to the drawings for the embodiments of the present disclosure. Obviously, those described are only a part, rather than all, of the embodiments of the present disclosure. Based on the embodiments in the present disclosure, any other embodiment obtained by those of ordinary skill in the art without paying any inventive effort should fall within the protection scope of the present disclosure.

As used herein, “first”, “second”, etc. are neither meant to specifically refer to an order or a sequence, nor used to limit the present disclosure, but merely intended to distinguish elements or operations described using the same technical terms.

As used herein, “include”, “comprise”, “have”, “contain”, etc. are open-ended terms which mean including, but not limited to.

As used herein, “and/or” includes any or all combinations of the described matters.

An embodiment of the present disclosure discloses a performance optimization method for training a mixture-of-experts model. The method includes:

judging, before one iterative calculation and for each of all experts in a mixture-of-experts model, whether a current expert needs to be set as a shadow expert, and if yes, adding the current expert to a shadow expert set, and continuing to judging whether a next expert needs to be set as a shadow expert until all the experts are judged.

In this embodiment, the judging whether the current expert needs to be set as the shadow expert specifically includes:
calculating a first total delay time of a mixture-of-experts model that is based on a current shadow expert set in an iterative calculation;
calculating a second total delay time of the mixture-of-experts model that is based on the current shadow expert set in an iterative calculation after adding the current expert to the shadow expert set; and
judging whether to set the current expert as a shadow expert based on the first total delay time and the second total delay time.

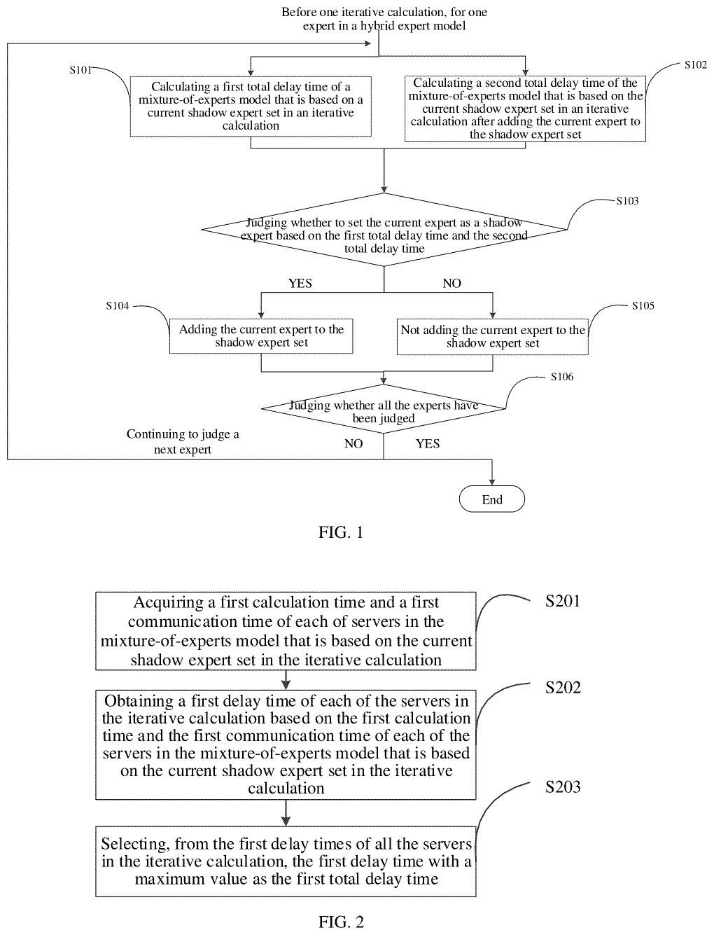

It can be understood that during implementations, as illustrated in FIG. 1, the method specifically includes the following steps.

Steps S101 and S102 are performed respectively for one expert in the mixture-of-experts model, before one iterative calculation.

S101: calculating a first total delay time of a mixture-of-experts model that is based on a current shadow expert set in an iterative calculation.

S102: calculating a second total delay time of the mixture-of-experts model that is based on the current shadow expert set in an iterative calculation after adding the current expert to the shadow expert set.

Next, performing step S103.

S103: judging whether to set the current expert as a shadow expert based on the first total delay time and the second total delay time.

If yes, performing step S104.

S104: adding the current expert to the shadow expert set.

If not, performing step S105.

S105: not adding the current expert to the shadow expert set.

Next, performing step S106.

S106: judging whether all the experts have been judged.

If yes, the steps of the method are ended; and if not, it is continued to judge a next expert.

According to the performance optimization method and apparatus for training a mixture-of-experts model provided by the present disclosure, it is judged, before one iterative calculation and for each of all experts in a mixture-of-experts model, whether a current expert needs to be set as a shadow expert; if yes, the current expert is added to a shadow expert set, and it is continued to judge whether a next expert needs to be set as a shadow expert until all the experts are judged. Thus, it is possible to reduce the number of pieces of input data processed by a singular expert in a server in the mixture-of-experts model during training, thereby reducing a processing load of the singular expert in the server, and it is also possible to reduce the number of times of communications of the input data transmitted across the server, thereby improving the training speed and efficiency of the mixture-of-experts model, and reducing the resources consumed in the mixture-of-experts model during training. By calculating a first total delay time of a mixture-of-experts model that is based on a current shadow expert set in an iterative calculation, it is possible to obtain the time spent by the mixture-of-experts model that is based on the current shadow expert set in one training process, i.e., one iterative calculation. By calculating a second total delay time of the mixture-of-experts model iterative calculation that is based on the current shadow expert set in an iterative calculation after adding the current expert to the shadow expert set, it is possible to obtain the time spent by the mixture-of-experts model that is based on the current shadow expert set after adding the current expert to the shadow expert set in one training process, i.e., one iterative calculation. By judging whether to set the current expert as a shadow expert based on the first total delay time and the second total delay time, it is possible to judge whether the time spent by the mixture-of-experts model in one training process can be reduced after the current expert is set as a shadow expert, thereby improving the training speed and efficiency of the mixture-of-experts model. To sum up, the performance optimization method and apparatus for training a mixture-of-experts model provided by the present disclosure can improve the training speed and efficiency of the mixture-of-experts model and reduce the resources consumed in the mixture-of-experts model during training.

In an optional embodiment, as illustrated in FIG. 2, the calculating a first total delay time of a mixture-of-experts model that is based on a current shadow expert set in an iterative calculation specifically includes the following steps:

S201: acquiring a first calculation time and a first communication time of each of servers in the mixture-of-experts model that is based on the current shadow expert set in the iterative calculation;

S202: obtaining a first delay time of each of the servers in the iterative calculation based on the first calculation time and the first communication time of each of the servers in the mixture-of-experts model that is based on the current shadow expert set in the iterative calculation; and

S203: selecting, from the first delay times of all the servers in the iterative calculation, the first delay time with a maximum value as the first total delay time.

Specifically, one iterative calculation corresponds to one training process of the mixture-of-experts model that is based on the current shadow expert set, including a forward calculation and a backward calculation, and the processes and contents of the forward calculation and the backward calculation are known to the art and are not repeated here.

As an example, the mixture-of-experts model may be located in, but not limited to, a module such as a feedforward layer of a Transformer model. The mixture-of-experts model may also be located in any other module or layer of a neural network, which is not limited in the embodiments of the present disclosure.

As an example, the first calculation time is a sum of the times of matrix multiplication operations involved in the forward calculation and backward calculation of the mixture-of-experts model that is based on the current shadow expert set. The operation mode is not limited to the matrix multiplication operation, and those skilled in the art may select other operation modes according to the actual situation.

As an example, the first communication time is a sum of a communication time for a current server in the mixture-of-experts model that is based on the current shadow expert set to send target input data to a server where an expert capable of processing the target input data is located, and a communication time for retrieving the processed target input data to the current server.

As an example, the first delay time of each of the servers in the iterative calculation is the time spent by each of the servers of the mixture-of-experts model that is based on the current shadow expert set in one iterative calculation.

Specifically, the first total delay time is the time spent by a server which spends a longest time in one iterative calculation in the mixture-of-experts model that is based on the current shadow expert set, i.e., a longest time among the times spent by all the servers in the mixture-of-experts model in the current iteration calculation, after all shadow experts in the current shadow expert set are copied and sent to all other servers in the mixture-of-experts model.

By calculating the first total delay time of the mixture-of-experts model that is based on the current shadow expert set in the iterative calculation, it is possible to obtain the time spent by the mixture-of-experts model that is based on the current shadow expert set in one training process, i.e., one iterative calculation.

In an optional embodiment, the acquiring the first calculation time and the first communication time of each of servers in the mixture-of-experts model that is based on the current shadow expert set in the iterative calculation includes:
obtaining the first calculation time based on a first input data amount of each of the servers, a hidden layer size ratio, a feature vector length of the mixture-of-experts model and a calculation throughput; and
obtaining the first communication time based on the first input data amount of each of the servers, the feature vector length of the mixture-of-experts model and a network bandwidth.

As an example, the first calculation time is

$$3 \frac{4 {B}_{w} α {H}^{2}}{P} ,$$

where B_{w} represents the first input data amount, a represents the hidden layer size ratio, H represents the feature vector length of the mixture-of-experts model, and P represents the calculation throughput. In the embodiment of the present disclosure, the first calculation time is the sum of the times of the matrix multiplication operations involved in the forward calculation and the backward calculation, the forward calculation requires one matrix multiplication operation and the backward calculation requires two matrix multiplication operations, with a total of three matrix multiplication operations, whereas the time spent by one matrix multiplication operation is

$$\frac{4 {B}_{w} α {H}^{2}}{P} ,$$

and there are three matrix multiplication operations in total, so the first calculation time is

$$3 \frac{4 {B}_{w} α {H}^{2}}{P} .$$

As an example, the first communication time is

$$4 \frac{{B}_{w} H}{{W}_{net}} ,$$

where B_{w} represents the first input data amount, H represents the feature vector length of the mixture-of-experts model, and Wₑₜ represents the network bandwidth. In the embodiment of the present disclosure, the first communication time is the sum of the communication time for the current server sends the target input data to a server where the expert capable of processing the target input data is located, and the communication time for retrieving the processed target input data to the current server. The forward calculation needs to carry out twice the communication of sending the target input data to the server where the expert capable of processing the target input data is located and the communication of retrieving the processed target input data to the current server. The backward calculation also needs to carry out twice the communication of sending the target input data to the server where the expert capable of processing the target input data is located and the communication of retrieving the processed target input data to the current server. So, there are four communications in total, where the time of one communication is

$$\frac{{B}_{w} H}{{W}_{net}} ,$$

so the first communication time is

$$4 \frac{{B}_{w} H}{{W}_{net}} .$$

In an optional embodiment, the obtaining the first delay time of each of the servers in the iterative calculation based on the first calculation time and the first communication time of each of the servers in the mixture-of-experts model that is based on the current shadow expert set in the iterative calculation includes:
summing the first calculation time and the first communication time of each of the servers in the iterative calculation to obtain the first delay time of each of the servers in the iterative calculation.

As an example, the first delay time is expressed as

$$( 3 \frac{4 {B}_{w} α {H}^{2}}{P} + 4 \frac{{B}_{w} H}{{W}_{net}} ) .$$

Correspondingly, the first total delay time is expressed as the following equation:

$${Lat}_{i ntol} ( B ) = {max}_{w} \{ 3 \frac{4 {B}_{w} α {H}^{2}}{P} + 4 \frac{{B}_{w} H}{{W}_{net}} \}$$

where imbl represents a load imbalance, w represents the server, b represents a parameter of the first input data amount, and Lat_{i nbl}(B) represents the first total delay time.

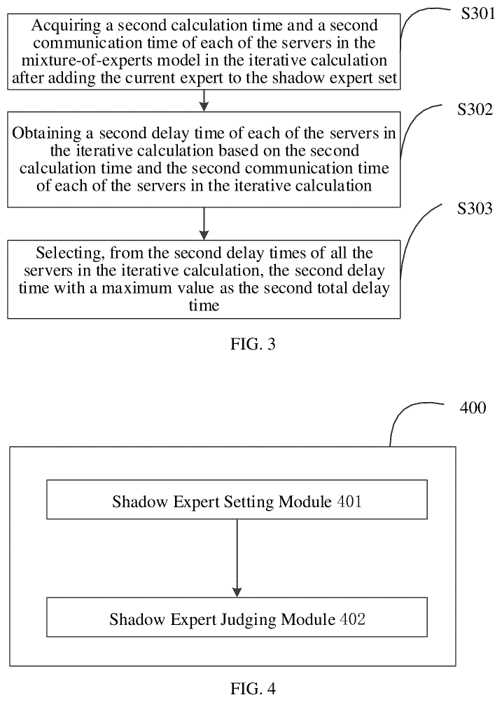

In an optional embodiment, as illustrated in FIG. 3, the calculating the second total delay time of the mixture-of-experts model that is based on the current shadow expert set in the iterative calculation after adding the current expert to the shadow expert set specifically includes the following steps:
S301: acquiring a second calculation time and a second communication time of each of the servers in the mixture-of-experts model in the iterative calculation after adding the current expert to the shadow expert set;
S302: obtaining a second delay time of each of the servers in the iterative calculation based on the second calculation time and the second communication time of each of the servers in the iterative calculation; and
S303: selecting, from the second delay times of all the servers in the iterative calculation, the second delay time with a maximum value as the second total delay time.

Specifically, one iterative calculation corresponds to one training process of the mixture-of-experts model after adding the current expert to the shadow expert set, including a forward calculation and a backward calculation, the processes and contents of the forward calculation and the backward calculation are known to the art and are not repeated here.

As an example, the mixture-of-experts model may be located in, but not limited to, a module such as a feedforward layer in a Transformer model. The mixture-of-experts model may also be located in any other module or layer in a neural network, which is not limited in the embodiments of the present disclosure.

As an example, the second calculation time is a sum of the times of matrix multiplication operations involved in the forward calculation and backward calculation of the mixture-of-experts model after adding the current expert to the shadow expert set. The operation mode is not limited to the matrix multiplication operation, and those skilled in the art may select other operation modes according to the actual situation.

As an example, the second communication time is a communication time for the current server of the mixture-of-experts model after adding the current expert to the shadow expert set to send a shadow model, which is obtained by copying the current expert that is served as a shadow expert, to other servers in the mixture-of-experts model. As for the sum of the communication time for sending the target input data to the server where the expert capable of processing the target input data is located, and the communication time for retrieving the processed target input data to the current server, since it is assumed that the shadow model obtained by copying the current expert that is served as a shadow expert has been sent to the mixture-of-experts model, the target input data on other servers is no longer transmitted to corresponding experts through cross-server communication, and only needs to be transmitted within the server to the shadow model for processing. Thus, the sum of the communication time for sending the target input data to the server where the expert capable of processing the target input data is located, and the communication time for retrieving the processed target input data to the current server is ignored as zero.

As an example, the second delay time of each of the servers in the iterative calculation is the time spent by each of the servers of the mixture-of-experts model in one iterative calculation after adding the current expert to the shadow expert set.

Specifically, the second total delay time is the time spent by a server which spends a longest time in one iterative calculation in the mixture-of-experts model after adding the current expert to the shadow expert set, i.e., a longest time among the time spent by all the servers in the mixture-of-experts model in the current iteration calculation, after the current expert is added to the shadow expert set and all the shadow experts in the shadow expert set having been added with the current expert are copied and sent to all other servers in the mixture-of-experts model.

By calculating the second total delay time of the mixture-of-experts model that is based on the current shadow expert set in the iterative calculation after adding the current expert to the shadow expert set, it is possible to obtain the time spent by the mixture-of-experts model in one training process after adding the current expert to the shadow expert set, i.e., one iterative calculation.

In an optional embodiment, the acquiring the second calculation time and the second communication time of each of the servers in the mixture-of-experts model in the iterative calculation after adding the current expert to the shadow expert set includes:
obtaining the second calculation time based on a second input data amount of each of the servers, a hidden layer size ratio, a feature vector length of the mixture-of-experts model and a calculation throughput; and
obtaining the second communication time based on the number of shadow experts in the shadow expert set, the hidden layer size ratio, the feature vector length of the mixture-of-experts model and a network bandwidth.

As an example, the second calculation time is

$$3 \frac{4 {B}_{w} α {H}^{2}}{P} ,$$

where B_{w} represents the second input data amount, a represents the hidden layer size ratio, H represents the feature vector length of the mixture-of-experts model, and P represents the calculation throughput. In the embodiment of the present disclosure, the second calculation time is the sum of the times of the matrix multiplication operations involved in the forward calculation and the backward calculation, the forward calculation requires one matrix multiplication operation and the backward calculation requires two matrix multiplication operations, with a total of three matrix multiplication operations, where the time of one matrix multiplication operation is

$$\frac{4 {B}_{w} α {H}^{2}}{P} ,$$

and there are three matrix

$$3 \frac{4 {B}_{w} α {H}^{2}}{P} .$$

multiplication operations in total, so the first calculation time is Specifically, the second input data amount B_{w} is different from the first input data amount B_{w} in the embodiment of the present disclosure, because after the current expert is copied by serving as a shadow expert to obtain a shadow model and the shadow model of all the shadow experts are sent to other servers in the mixture-of-experts model, any input data originally corresponding to the current expert on other servers does not need to be sent to the current server where the current expert is located for processing through cross-server communication, and only needs to be sent within the server to the shadow model for processing, so at this time, the number of inputs to be processed by each of the servers is recalculated to obtain the second input data amount B_{w}. It should be noted that the step of recalculating the number of inputs to be processed by each of the servers to obtain the second input data amount B_{w} is a conventional technical means in the art, which is not repeated here.

As an example, the second communication time is

$$2 r \frac{2 α H}{{W}_{net}} ,$$

where r represents the number of shadow experts in the shadow expert set, a represents the hidden layer size ratio, H represents the feature vector length of the mixture-of-experts model, and Wₑₜ represents the network bandwidth.

In an optional embodiment, the obtaining the second delay time of each of the servers in the iterative calculation based on the second calculation time and the second communication time of each of the servers in the iterative calculation includes:
summing the second calculation time and the second communication time of each of the servers in the iterative calculation to obtain the second delay time of each of the servers in the iterative calculation.

As an example, the second delay time is expressed as

$$( 3 \frac{4 {B}_{w} α {H}^{2}}{P} + 2 r \frac{2 α H}{{W}_{net}} ) .$$

Correspondingly, the second total delay time is expressed as the following equation:

$${Lat}_{shadow} ( r , b ) = {max}_{w} \{ 3 \frac{4 {B}_{w} α {H}^{2}}{P} + 2 r \frac{2 α H}{{W}_{net}} \}$$

where shadow represents a shadow, w represents a server, B′ represents a parameter of the second input data amount, and Lat _{shadow}(r, B) represents the second total delay time.

In an optional embodiment, the judging whether to set the current expert as a shadow expert based on the first total delay time and the second total delay time includes:
judging whether the second total delay time is less than the first total delay time; if yes, judging to set the current expert as a shadow expert; and if not, judging not to set the current expert as a shadow expert.

By judging whether to set the current expert as the shadow expert based on the first total delay time and the second total delay time, it is possible to judge whether the time spent by the mixture-of-experts model in one training process can be reduced after the current expert is set as the shadow expert, thereby improving the speed and efficiency of training the mixture-of-experts model.

In an optional embodiment, before calculating the first total delay time of the mixture-of-experts model that is based on the current shadow expert set in the iterative calculation, the method further includes:

acquiring an input data amount of each of all the experts, and sorting all the experts in a descending order of the input data amounts of all the experts, to sequentially judge whether the current expert needs to be set as a shadow expert for each of all the experts according to the order after the sorting.

By sorting all the experts in a descending order of the input data amounts of all the experts, it is possible to reduce the calculation complexity of the subsequent judgment and the setting of the shadow expert, thereby reducing the time of the performance optimization process of training the mixture-of-experts model, and indirectly improving the efficiency of training the mixture-of-experts model and reducing the calculation resources consumed.

In an optional embodiment, the method further includes an iterative calculation process of:
copying each of the shadow experts in the shadow expert set to obtain a shadow model, and sending the shadow models of all the shadow experts to other servers in the mixture-of-experts model;
calculating gradients of the experts and the shadow models by the shadow models and the experts on all the servers in the mixture-of-experts model based on the corresponding input data, and returning the gradients of the shadow models to the servers of the respective shadow experts; and
obtaining the gradients of the shadow experts based on the gradients of all the received shadow models, obtaining a comprehensive gradient based on the gradients of the shadow experts and other experts, and updating all the experts based on the comprehensive gradient.

By updating all the experts based on the comprehensive gradient, it is possible to improve the accuracy of the output calculated by the expert in the mixture-of-experts model based on the input, which is a necessary process for the model training for the neural network. The specific content of the iterative calculation process is known to the art, and is not described here.

In an optional embodiment, before the calculating the first total delay time of the mixture-of-experts model that is based on the current shadow expert set in the iterative calculation, the method further includes a process of matching input data with each of all the experts in the mixture-of-experts model:
calculating, for each of all input data of the mixture-of-experts model, a matching score between the input data and each of all the experts in the mixture-of-experts model, and matching the input data with an expert having a highest matching score;
judging, for each of all the experts in the mixture-of-experts model, whether an amount of input data passing through an upper-layer network in the input data and matched with the expert is less than a first preset amount; if yes, ending the process of matching the input data with the expert; and if not, selecting a first preset amount of input data having a highest matching score from the input data passing through the upper-layer network; and
re-matching each of the unselected input data passing through the upper-layer network with the expert having the highest matching score and not communicating through the upper-layer network.

As an example, the calculating the matching score between the input data and each of all the experts in the mixture-of-experts model may be implemented by, but not limited to, the existing gate network module in the mixture-of-experts model. Specifically, the matching the input data with an expert having a highest matching score means that the input data is input to a server where an expert having the highest matching score is located, and then can be input to the expert having the highest matching score.

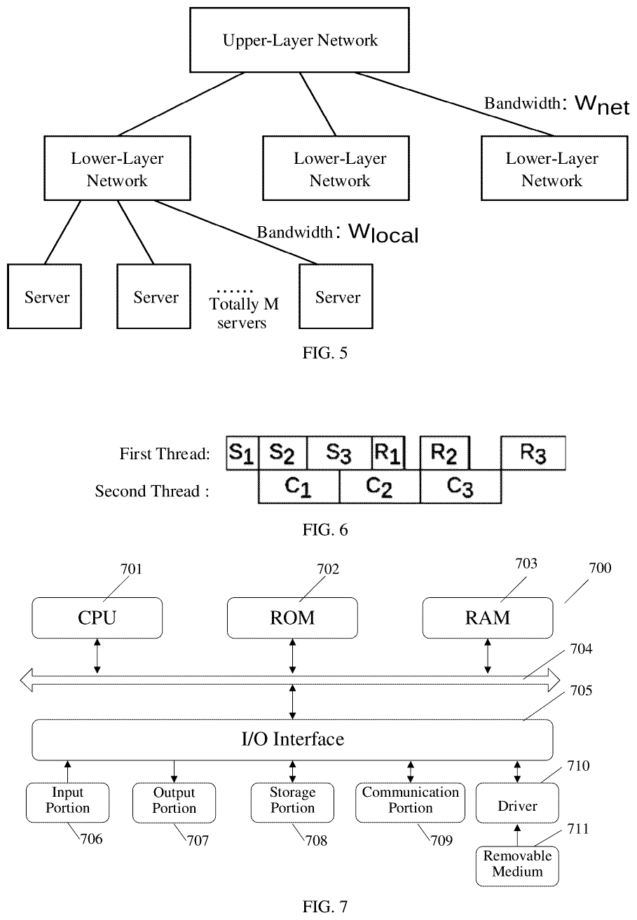

As an example, as illustrated in FIG. 5, in the embodiment of the present disclosure, a network architecture involved in the mixture-of-experts model includes an upper-layer network and a lower-layer network.

As an example, the upper-layer network may be a network including a switch and a plurality of routers connected to the switch, and a layout and a scope of the upper-layer network may be determined by those skilled in the art according to the actual situation, which is not limited in the embodiments of the present disclosure.

As an example, the lower-layer network may be a network including a router and a plurality of servers connected to the switch, and a layout and a scope of the lower-layer network may be determined by those skilled in the art according to the actual situation, which is not limited in the embodiments of the present disclosure.

As an example, the input data passing through the upper-layer network may be input data originally in a server in a certain lower-layer network and needing to be transmitted to the experts in the servers in other lower-layer networks for processing. Correspondingly, the input data not passing through the upper-layer network may be input data originally in a server in a certain lower-layer network and only needing to be transmitted to the experts in the server in the same lower-layer network for processing.

As an example, the selecting the first preset amount of input data having the highest matching score from the input data passing through the upper-layer network means reserving the first preset amount of input data having a highest matching score among the input data passing through the upper-layer network and matched with the current expert, and disabling the matching for other input data passing through the upper-layer network and matched with the current expert, i.e., originally other input data passing through the upper-layer network and matched with the current experts is not allowed to be transmitted to the server where the current expert is located, and then not allowed to be transmitted to the current expert.

As an example, the expert not communicating through the upper-layer network is an expert for which none of the input data currently transmitted to the expert passes through the upper-layer network.

Specifically, the bandwidth of the upper-layer network is lower than that of the lower-layer network. The fact that the bandwidth of the upper-layer network is lower than that of the lower-layer network is caused by the hardware characteristics of training neural network in the prior art, which will not be described here. In addition, the fact that the bandwidth of the upper-layer network is lower than that of the lower-layer network is also caused by the network structure design in the prior art to save the communication cost.

By matching the input data with each of all the experts in the mixture-of-experts model, it is possible to improve the throughput of the mixture-of-experts model iterative calculation by reducing the congestion of the upper-layer network, thereby improving the training speed and efficiency of the mixture-of-experts model.

In an optional embodiment, the first preset amount is determined by a process of:

determining the first preset amount based on a bandwidth of the upper-layer network, a bandwidth of the lower-layer network, an amount of the input data to be sent by each of the servers in each of the lower-layer networks, and the number of the experts in each of the lower-layer networks.

As an example, the first preset amount is determined by the following equation:

$$L = \frac{{BW}_{net}}{M {W}_{local}}$$

where L represents the first preset amount, B represents the amount of the input data to be sent by each of the servers in each of the lower-level networks, Wₑₜ represents the bandwidth of the upper-level network, W_{ocal} represents the bandwidth of the lower-level network, and M represents the number of the experts in each of the lower-layer networks.

By setting the first preset amount, it is possible to define a maximum amount of the input data received by each of the servers through the upper-layer network, thereby reducing the delays in the upper-layer network and the lower-layer network, and further improving the speed of training the mixture-of-experts model.

In an optional embodiment, after the judging whether to set the current expert as the shadow expert based on the first total delay time and the second total delay time, the method further includes:
grouping all the servers where the experts in the mixture-of-experts model are located according to a preset grouping mode to obtain a plurality of server groups;
allocating, for each of the plurality of server groups, a process that a current server group receives the input data sent by other server groups, a process that the current server group calculates the input data sent by other server groups, and the process that the current server group sends a calculation result back to other server groups, to a plurality of threads based on a sequential dependency of the processes.

As an example, the preset grouping mode should follow the following principles:
after the grouping, the communication between the servers in each of the server groups should be as quick as possible; the server groups should be continuous in the network structure, so that the communication between the server groups also could be as quick as possible, and for example, the server groups are in a same switch subnet. It should be noted that the grouping mode of the servers may be that in the prior art adopted by those skilled in the art according to the actual situation, which is not limited in the embodiments of the present disclosure.

By grouping the servers, and performing the step of allocating a process that a current server group receives the input data sent by other server groups, the process that the current server group calculates the input data sent by other server groups, and the process that the current server group sends a calculation result back to other server groups to a plurality of threads based on a sequential dependency of the processes, the synchronization of the plurality of threads can be utilized to improve the speed and efficiency of the transmission of the input data between the servers, thereby improving the speed and efficiency of training the mixture-of-experts model and reducing the resources consumed in the mixture-of-experts model during training. In addition, by allocating the above processes to the plurality of threads based on the sequential dependency, a deadlock can be avoided and the iterative calculation of the mixture-of-experts model can be guaranteed to be performed stably.

It should be noted that the number of the threads is not limited in the embodiments of the present disclosure, and may be determined by those skilled in the art according to the actual situation.

In an optional embodiment, the preset grouping mode is based on a pairwise exchange algorithm or a groupwise exchange algorithm, which is the prior art and will not be described here.

In an optional embodiment, the plurality of threads include a first preset thread and a second preset thread.

In an optional embodiment, the allocating the process that the current server group receives the input data sent by other server groups, the process that the current server group calculates the input data sent by other server groups, and the process that the current server group sends the calculation result back to other server groups, to the plurality of threads based on the sequential dependency of the processes specifically includes:
allocating the process that the current server group receives the input data sent by other server groups and the process that the current server group sends the calculation result back to other server groups to the first thread based on the sequential dependency of the processes, and allocating the process that the current server group calculates the input data sent by other server groups to the second thread based on the sequential dependency of the processes.

As an example, as illustrated in FIG. 6, S1 represents a process that the current server group receives the input data sent by a first server group in other server groups, S2 represents a process that the current server group receives the input data sent by a second server group in other server groups, and S3 represents a process that the current server group receives the input data sent by a third server group in other server groups; R1 represents a process that the current server group sends the calculation result back to the first server group in other server groups, R2 represents a process that the current server group sends the calculation result back to the second server group in other server groups, and R3 represents a process that the current server group sends the calculation result back to the third server group in other server groups; C1 represents a process that the current server group calculates the input data sent by the first server group in other server groups, C2 represents a process that the current server group calculates the input data sent by the second server group in other server groups, and C3 represents a process that the current server group calculates the input data sent by the third server group in other server groups.

Specifically, the sequential dependency of the processes is to schedule in an order of the process that the machine group receives the input data sent by another machine group, the process that the machine group calculates the input data sent by another machine group, and the process that the machine group sends the calculation result back to another machine group, in which the process that the machine group receives the input data sent by another machine group, the process that the machine group calculates the input data sent by another machine group, and the machine group sends the calculation result back to another machine group do not overlap in terms of time.

As an example, as illustrated in FIG. 6, for the communication between the current server and the first server in other server group, there is an order of S1=>C1=>R1, in which both S1 and R1 are performed on the first thread, and C1 is performed on the second thread. As can be seen from FIG. 6, S1, C1 and R1 do not overlap on the time axis. For S2, C2, R2, S3, C3, R3, please refer to the above description of S1, C1, R1, and the principle is the same, which will not be repeated here. It should be noted that the first thread and the second thread share the same time axis, and the thread allocation diagram can be directly understood by those skilled in the art according to the common knowledge in the art, and the principle of the thread allocation diagram is not described here.

It should be noted that the above descriptions of the embodiments of the present disclosure are only examples, rather than limitations to the present disclosure. The current server group is not limited to the communications with the first server group, the second server group and the third server group in other server groups. For example, the current server group may be communicated with itself or with a fourth server group in other server groups.

Based on the same principle, an embodiment of the present disclosure discloses a performance optimization apparatus 400 for training a mixture-of-experts model, as illustrated in FIG. 4, which includes:
a shadow expert setting module 401 configured to judge, before one iterative calculation and for each of all experts in a mixture-of-experts model, whether a current expert needs to be set as a shadow expert, and if yes, adding the current expert to a shadow expert set, and continuing to judging whether a next expert needs to be set as a shadow expert until all the experts are judged; and
a shadow expert judging module 402 configured to calculate a first total delay time of a mixture-of-experts model that is based on a current shadow expert set in an iterative calculation; calculate a second total delay time of the mixture-of-experts model that is based on the current shadow expert set in an iterative calculation after adding the current expert to the shadow expert set; and judge whether to set the current expert as the shadow expert based on the first total delay time and the second total delay time.

In an optional embodiment, the shadow expert judging module 402 includes a first total delay time determining unit, which is configured to:
acquire a first calculation time and a first communication time of each of servers in the mixture-of-experts model that is based on the current shadow expert set in the iterative calculation;
obtain a first delay time of each of the servers in the iterative calculation based on the first calculation time and the first communication time of each of the servers in the mixture-of-experts model that is based on the current shadow expert set in the iterative calculation; and
select, from the first delay times of all the servers in the iterative calculation, the first delay time with a maximum value as the first total delay time.

In an optional embodiment, the first total delay time determining unit is configured to:
obtain the first calculation time based on a first input data amount of each of the servers, a hidden layer size ratio, a feature vector length of the mixture-of-experts model and a calculation throughput; and
obtain the first communication time based on the first input data amount of each of the servers, the feature vector length of the mixture-of-experts model and a network bandwidth.

In an optional embodiment, the first total delay time determining unit is configured to:
sum the first calculation time and the first communication time of each of the servers in the iterative calculation to obtain the first delay time of each of the servers in the iterative calculation.

In an optional embodiment, the shadow expert judging module 402 includes a second total delay time determining unit, which is configured to:
acquire a second calculation time and a second communication time of each of the servers in the mixture-of-experts model in the iterative calculation after adding the current expert to the shadow expert set;
obtain a second delay time of each of the servers in the iterative calculation based on the second calculation time and the second communication time of each of the servers in the iterative calculation; and
select, from the second delay times of all the servers in the iterative calculation, the second delay time with a maximum value as the second total delay time.

In an optional embodiment, the second total delay time determining unit is configured to:
obtain the second calculation time based on a second input data amount of each of the servers, a hidden layer size ratio, a feature vector length of the mixture-of-experts model and a calculation throughput; and
obtain the second communication time based on the number of shadow experts in the shadow expert set, the hidden layer size ratio, the feature vector length of the mixture-of-experts model and a network bandwidth.

In an optional embodiment, the second total delay time determining unit is configured to:
sum the second calculation time and the second communication time of each of the servers in the iterative calculation to obtain the second delay time of each of the servers in the iterative calculation.

In an optional embodiment, the shadow expert judging module 402 is further configured to:
judge whether the second total delay time is less than the first total delay time; if yes, judge to set the current expert as a shadow expert; and if not, judge not to set the current expert as a shadow expert.

In an optional embodiment, the apparatus further includes a sorting module, which is configured to:
acquire an input data amount of each of all the experts, and sort all the experts in a descending order of the input data amounts of all the experts, to sequentially judge whether the current expert needs to be set as a shadow expert for each of all the experts according to the order after the sorting.

In an optional embodiment, the apparatus further includes a matching module configured to:
calculate, for each of all input data of the mixture-of-experts model, a matching score between the input data and each of all the experts in the mixture-of-experts model, and match the input data with an expert having a highest matching score;
judge, for each of all the experts in the mixture-of-experts model, whether an amount of input data passing through an upper-layer network in the input data and matched with the expert is less than a first preset amount; if yes, end the process of matching the input data with the expert; and if not, select a first preset amount of input data having a highest matching score from the input data passing through the upper-layer network; and
re-match each of the unselected input data passing through the upper-layer network with the expert having the highest matching score and not communicating through the upper-layer network.

In an optional embodiment, the matching module is further configured to:
determine the first preset amount based on a bandwidth of the upper-layer network, a bandwidth of the lower-layer network, an amount of the input data to be sent by each of the servers in each of the lower-layer networks, and the number of the experts in each of the lower-layer networks.

In an optional embodiment, the apparatus further includes a thread allocation module configured to:
group all the servers where the experts in the mixture-of-experts model are located according to a preset grouping mode to obtain a plurality of server groups;
allocate, for each of the plurality of server groups, a process that a current server group receives the input data sent by other server groups, a process that the current server group calculates the input data sent by other server groups, and the process that the current server group sends a calculation result back to other server groups, to a plurality of threads based on a sequential dependency of the processes.

In an optional embodiment, the preset grouping mode is a grouping mode based on a pairwise exchange algorithm or a groupwise exchange algorithm.

In an optional embodiment, the plurality of threads include a first preset thread and a second preset thread.

In an optional embodiment, the thread allocation module is further configured to:
allocate the process that the current server group receives the input data sent by other server groups and the process that the current server group sends the calculation result back to other server groups to the first thread based on the sequential dependency of the processes, and allocate the process that the current server group calculates the input data sent by other server groups to the second thread based on the sequential dependency of the processes.

In an optional embodiment, the apparatus further includes an iterative calculation module configured to:
copy each of the shadow experts in the shadow expert set to obtain a shadow model, and send the shadow models of all the shadow experts to other servers in the mixture-of-experts model;
calculate gradients of the experts and the shadow models by the shadow models and the experts on all the servers in the mixture-of-experts model based on the corresponding input data, and return the gradients of the shadow models to the servers of the respective shadow experts; and
obtain the gradients of the shadow experts based on the gradients of all the received shadow models, obtain a comprehensive gradient based on the gradients of the shadow experts and other experts, and update all the experts based on the comprehensive gradient.

The system, apparatus, module or unit set forth in the above embodiments may be implemented by a computer chip or an entity, or by a product having certain functions. A typical implementation device is a computer device. Specifically, the computer device may be, for example, a personal computer, a laptop computer, a cellular phone, a camera phone, a smart phone, a personal digital assistant, a media player, a navigation device, an email device, a game console, a tablet computer, a wearable device or any combination thereof.

In a typical example, a computer device specifically includes a memory, a processor, and a computer program stored in the memory and executable on the processor, and when executing the program, the processor implements the above method.

Reference is now made to FIG. 7, which illustrates a structural diagram of a computer device 700 suitable for implementing an embodiment of the present disclosure.

As illustrated in FIG. 7, the computer device 700 includes a central processing unit (CPU) 701 which may perform various appropriate works and processing according to a program stored in a read-only memory (ROM) 702 or a program loaded into a random-access memory (RAM) 703 from a storage portion 708. The RAM 703 further stores various of programs and data required for operations by the system 700. The CPU 701, the ROM 702, and the RAM 703 are connected to each other via a bus 704. An input/output (I/O) interface 705 is also connected to the bus 704.

The following components are connected to the I/O interface 705: an input portion 706 including a keyboard, a mouse, etc.; an output portion 707 including a cathode ray tube (CRT), a liquid crystal feedback (LCD), a speaker, etc.; a storage portion 708 including a hard disk, etc.; and a communication portion 709 including a network interface card such as a LAN card, a modem, etc. The communication portion 709 implements communication processing via a network such as the Internet. A driver 710 is also connected to the I/O interface 705 as needed. A removable medium 711, such as a magnetic disk, an optical disk, a magneto-optical disk, a semiconductor memory, etc., is installed on the driver 710 as needed, so that a computer program read from the removable medium is installed on the storage portion 708 as required.

Particularly, according to the embodiments of the present disclosure, the procedure described above with reference to the flowchart may be implemented as a computer software program. For example, the embodiment of the present disclosure includes a computer program product including a computer program tangibly embodied on a machine-readable medium, and the computer program includes program codes for implementing the method illustrated in the flowchart. In such embodiment, the computer programs may be downloaded and installed from a network through the communication part 709 and/or installed from the removable medium 711.

The computer-readable medium includes permanent and non-permanent, removable and non-removable media, which can realize the information storage by any method or technique. The information can be computer readable instructions, data structures, program modules or other data. An example of the computer storage medium includes, but not limited to, a phase change memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskettes or other magnetic storage device or any other non-transmission medium, which can be used for the storage of information accessible to a computing device. According to the definitions herein, the computer readable medium does not include any temporary computer readable media (transitory media), such as modulated data signal and carrier wave.

For the convenience of description, the foregoing apparatus is described by being divided into various units in terms of functions. Of course, the functions of the units may be implemented in one or more pieces of software and/or hardware during the implementation of the present disclosure.

The present disclosure is described with reference to a flowchart and/or a block diagram of the method, apparatus (system) and computer program product according to the embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a special purpose computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory can produce manufacture articles including an instructing device which implements function(s) specified in one or more flows in the flowchart and/or one or more blocks in the block diagram.

These computer program instructions may also be loaded onto the computer or other programmable data processing devices, so that a series of operation steps are implemented on the computer or other programmable data processing devices to produce a processing implemented by the computer, thus the instructions executed on the computer or other programmable devices provide step(s) for implementing function(s) specified in one or more flows in the flowchart and/or one or more blocks in the block diagram.

Further to be noted, the term “comprise”, “include” or any other variant intends to cover the non-exclusive inclusions, so that a process, a method, a commodity or a device including a series of elements include not only those elements, but also other elements not explicitly listed, or further include inherent elements of such process, method, commodity or device. In a case where there is no further limitation, the elements defined by a sentence “comprising a . . . ” do not exclude other identical elements existing in the process, method, commodity or device including the elements.

Those skilled in the art should appreciate that any embodiment of the present disclosure can be provided as a method, a system or a computer program product. Therefore, the present disclosure can take the form of a full hardware embodiment, a full software embodiment, or an embodiment combining software and hardware. Moreover, the present disclosure can take the form of a computer program product implemented on one or more computer usable storage mediums (including, but not limited to, a magnetic disc memory, CD-ROM, optical storage, etc.) containing therein computer usable program codes.

The present disclosure may be described in the general context of computer executable instructions executed by the computer, e.g., the program module. In general, the program module includes routine, program, object, component, data structure, etc. executing a particular task or realizing a particular abstract data type. The present disclosure may also be put into practice in the distributed computing environments where tasks are executed by remote processing devices connected through a communication network. In the distributed computing environments, the program modules may be located in the local and remote computer storage medium both of which include the storage device.

The embodiments herein are all described in a progressive manner, and the same or similar portions of the embodiments can refer to each other. Each embodiment lays an emphasis on its distinctions from other embodiments. In particular, the system embodiment is simply described since it is substantially similar to the method embodiment, and please refer to the descriptions of the method embodiment for the relevant portion.

Those described above are just embodiments of the present disclosure, rather than limitations thereto. For those skilled in the art, the present disclosure may have various amendments or variations. Any amendment, equivalent substitution, improvement, etc. made under the spirit and principle of the present disclosure should fall within the scope of the claims of the present disclosure.

1. A performance optimization method for training a mixture-of-experts model, comprising:
judging, before one iterative calculation and for each of all experts in the mixture-of-experts model, whether a current expert needs to be set as a shadow expert, and if yes, adding the current expert to a shadow expert set, and continuing to judging whether a next expert needs to be set as a shadow expert until all the experts are judged;
wherein the judging whether the current expert needs to be set as the shadow expert comprises:
calculating a first total delay time of a mixture-of-experts model that is based on a current shadow expert set in an iterative calculation;
calculating a second total delay time of the mixture-of-experts model that is based on the current shadow expert set in an iterative calculation after adding the current expert to the shadow expert set; and
judging whether to set the current expert as the shadow expert based on the first total delay time and the second total delay time.

2. The method according to claim 1, wherein the calculating the first total delay time of the mixture-of-experts model that is based on the current shadow expert set in the iterative calculation comprises:
acquiring a first calculation time and a first communication time of each of servers in the mixture-of-experts model that is based on the current shadow expert set in the iterative calculation;
obtaining a first delay time of each of the servers in the iterative calculation based on the first calculation time and the first communication time of each of the servers in the mixture-of-experts model that is based on the current shadow expert set in the iterative calculation; and
selecting, from the first delay times of all the servers in the iterative calculation, the first delay time with a maximum value as the first total delay time.

3. The method according to claim 2, wherein the acquiring the first calculation time and the first communication time of each of servers in the mixture-of-experts model that is based on the current shadow expert set in the iterative calculation comprises:
obtaining the first calculation time based on a first input data amount of each of the servers, a hidden layer size ratio, a feature vector length of the mixture-of-experts model and a calculation throughput; and
obtaining the first communication time based on the first input data amount of each of the servers, the feature vector length of the mixture-of-experts model and a network bandwidth.

4. The method according to claim 2, wherein obtaining the first delay time of each of the servers in the iterative calculation based on the first calculation time and the first communication time of each of the servers in the mixture-of-experts model that is based on the current shadow expert set in the iterative calculation comprises:
summing the first calculation time and the first communication time of each of the servers in the iterative calculation to obtain the first delay time of each of the servers in the iterative calculation.

5. The method according to claim 1, wherein calculating the second total delay time of the mixture-of-experts model that is based on the current shadow expert set in the iterative calculation after adding the current expert to the shadow expert set comprises:
acquiring a second calculation time and a second communication time of each of the servers in the mixture-of-experts model in the iterative calculation after adding the current expert to the shadow expert set;
obtaining a second delay time of each of the servers in the iterative calculation based on the second calculation time and the second communication time of each of the servers in the iterative calculation; and
selecting, from the second delay times of all the servers in the iterative calculation, the second delay time with a maximum value as the second total delay time.

6. The method according to claim 5, wherein acquiring the second calculation time and the second communication time of each of the servers in the mixture-of-experts model in the iterative calculation after adding the current expert to the shadow expert set comprises:
obtaining the second calculation time based on a second input data amount of each of the servers, a hidden layer size ratio, a feature vector length of the mixture-of-experts model and a calculation throughput; and
obtaining the second communication time based on the number of shadow experts in the shadow expert set, the hidden layer size ratio, the feature vector length of the mixture-of-experts model and a network bandwidth.

7. The method according to claim 5, wherein obtaining the second delay time of each of the servers in the iterative calculation based on the second calculation time and the second communication time of each of the servers in the iterative calculation comprises:
summing the second calculation time and the second communication time of each of the servers in the iterative calculation to obtain the second delay time of each of the servers in the iterative calculation.

8. The method according to claim 1, wherein judging whether to set the current expert as a shadow expert based on the first total delay time and the second total delay time comprises:
judging whether the second total delay time is less than the first total delay time; if yes, judging to set the current expert as a shadow expert; and if not, judging not to set the current expert as a shadow expert.

9. The method according to claim 1, wherein before the calculating the first total delay time of the mixture-of-experts model that is based on the current shadow expert set in the iterative calculation, the method further comprises:
acquiring an input data amount of each of all the experts, and sorting all the experts in a descending order of the input data amounts of all the experts, to sequentially judge whether the current expert needs to be set as a shadow expert for each of all the experts according to the order after the sorting.

10. The method according to claim 1, wherein before the calculating the first total delay time of the mixture-of-experts model that is based on the current shadow expert set in the iterative calculation, the method further comprises a process of matching input data with each of all the experts in the mixture-of-experts model:
calculating, for each of all input data of the mixture-of-experts model, a matching score between the input data and each of all the experts in the mixture-of-experts model, and matching the input data with an expert having a highest matching score;
judging, for each of all the experts in the mixture-of-experts model, whether an amount of input data passing through an upper-layer network in the input data and matched with the expert is less than a first preset amount; if yes, ending the process of matching the input data with the expert; and
if not, selecting the first preset amount of input data having a highest matching score from the input data passing through the upper-layer network; and
re-matching each of the unselected input data passing through the upper-layer network with the expert having the highest matching score and not communicating through the upper-layer network.

11. The method according to claim 10, wherein the first preset amount is determined by a process of:
determining the first preset amount based on a bandwidth of the upper-layer network, a bandwidth of the lower-layer network, an amount of the input data to be sent by each of the servers in each of the lower-layer networks, and the number of the experts in each of the lower-layer networks.

12. The method according to claim 1, wherein after judging whether to set the current expert as a shadow expert based on the first total delay time and the second total delay time, the method further comprises:
grouping all the servers where the experts in the mixture-of-experts model are located according to a preset grouping mode to obtain a plurality of server groups; and
allocating, for each of the plurality of server groups, a process that a current server group receives the input data sent by other server groups, a process that the current server group calculates the input data sent by other server groups, and the process that the current server group sends a calculation result back to other server groups, to a plurality of threads based on a sequential dependency of the processes.

13. The method according to claim 12, wherein the preset grouping mode is based on a pairwise exchange algorithm or a groupwise exchange algorithm.

14. The method according to claim 12, wherein the plurality of threads include a preset first thread and a preset second thread.

15. The method according to claim 14, wherein the allocating the process that the current server group receives the input data sent by other server groups, the process that the current server group calculates the input data sent by other server groups, and the process that the current server group sends the calculation result back to other server groups, to the plurality of threads based on the sequential dependency of the processes specifically comprises:
allocating the process that the current server group receives the input data sent by other server groups and the process that the current server group sends the calculation result back to other server groups to the first thread based on the sequential dependency of the processes, and allocating the process that the current server group calculates the input data sent by other server groups to the second thread based on the sequential dependency of the processes.

16. The method according to claim 1, further comprising an iterative calculation process of:
copying each of the shadow experts in the shadow expert set to obtain a shadow model, and sending the shadow models of all the shadow experts to other servers in the mixture-of-experts model;
calculating gradients of the experts and the shadow models by the shadow models and the experts on all the servers in the mixture-of-experts model based on the corresponding input data, and returning the gradients of the shadow models to the servers of the respective shadow experts; and
obtaining the gradients of the shadow experts based on the gradients of all the received shadow models, obtaining a comprehensive gradient based on the gradients of the shadow experts and other experts, and updating all the experts based on the comprehensive gradient.

17. A performance optimization apparatus for training a mixture-of-experts model, comprising:
a shadow expert setting module configured to judge, before one iterative calculation and for each of all experts in a mixture-of-experts model, whether a current expert needs to be set as a shadow expert, and if yes, adding the current expert to a shadow expert set, and continuing to judging whether a next expert needs to be set as a shadow expert until all the experts are judged; and
a shadow expert judging module configured to calculate a first total delay time of a mixture-of-experts model that is based on a current shadow expert set in an iterative calculation; calculate a second total delay time of the mixture-of-experts model that is based on the current shadow expert set in an iterative calculation after adding the current expert to the shadow expert set; and judge whether to set the current expert as the shadow expert based on the first total delay time and the second total delay time.

18. A computer device, comprising a memory, a processor and a computer program stored in the memory and executable on the processor, wherein when executing the program, the processor implements method comprising:
judging, before one iterative calculation and for each of all experts in the mixture-of-experts model, whether a current expert needs to be set as a shadow expert, and if yes, adding the current expert to a shadow expert set, and continuing to judging whether a next expert needs to be set as a shadow expert until all the experts are judged;
wherein the judging whether the current expert needs to be set as the shadow expert comprises:
calculating a first total delay time of a mixture-of-experts model that is based on a current shadow expert set in an iterative calculation;
calculating a second total delay time of the mixture-of-experts model that is based on the current shadow expert set in an iterative calculation after adding the current expert to the shadow expert set; and
judging whether to set the current expert as the shadow expert based on the first total delay time and the second total delay time.

19. (canceled)
